(19) United States
(12) Patent Application Publication
(10) Pub. No.: US 2004/0063806 A1
(43) Pub. Date: Apr. 1, 2004

(54) Antimicrobial polyalphaolefin composition

(76) Inventor: Matti Kaarnakari, Luoma (FI)

Correspondence Address: YOUNG & THOMPSON, 745 SOUTH 23RD STREET 2ND FLOOR, ARLINGTON, VA, 22202

(21) Appl. No.: 10/398,245

(22) PCT Filed: Oct. 12, 2001
(86) PCT No.: PCT/FI01/00887

(30) Foreign Application Priority Data
Oct. 12, 2000 (FI) 20002245

(51) Int. Cl. C08K 3/00

(52) U.S. Cl. 523/122

(57) ABSTRACT

The present invention relates to an antimicrobial polyalphaolefin composition comprising polyalphaolefin and triclosan and/or paraben as antimicrobial compound(s). The composition may be used either as such in various applications, or as a starting material for producing products that should have antimicrobial properties.

The present invention relates to an antimicrobial polyalphaolefin composition comprising polyalphaolefin and an antimicrobial compound. The composition may be used either as such in various applications, or as a starting material for producing products that should have antimicrobial properties.

Various antimicrobial formulations such as solutions, compositions for cleaning purposes and like are commonly used to desinfect surfaces and instruments. In technochemical, cosmetics, pharmaceutical and food industries as well as in hospitals, antimicrobial products are used to prevent the growth of microbes such as bacteria, fungi, moulds, and yeasts. Further, said products are used to control the health risk, and the deterioration of products and the development of bad odour therein and the discolouration thereof due to microbes. In food industry, problems are caused by the protecting and lubricating oils used in machines and apparatuses allowing microbial e.g. Listeria bacterial growth under favourable conditions. Droplets of such contaminated lubricating oil entering the products form a serious health hazard.

Patent NO 180104 discloses a liquid silicone oil containing antibacterial agents such as triclosan, and the use thereof to fill dental cavities in connection with dental bridges and prosthesis.

Patent publication JP 07021091 presents a microbicidal polyolefin composition comprising polyolefins containing chlorine compounds, bactericidal compounds, phosphorus compounds, phenolic compounds and neutralizing compounds.

U.S. Pat. No. 5,069,907 discusses cloth materials used in surgery. This material consists of synthetic polymer film or a cloth containing 0.01-25% by weight of an antimicrobial agent, preferably 2,4,4′-trichloro-2′-hydroxyphenyl ether. Alternatively, the cloth may comprise so-called fastening agent between the skin and the cloth, mixed with said antimicrobial agent. Suitable fastening agents are the following: polyvinyl ether, acrylic binder, polyolefin, silicone binder, polyester, and polyurethane.

Patent application WO 99/37710 is directed to polymeric compounds containing at least one phenolic compound in an amount of 0.01 to 10% by weight, the corresponding master batch, and the production and use thereof. The polymeric compounds mentioned include polyolefins selected in this case from: polyethylene and the derivatives thereof, LDPE, HDPE, LLDPE, EVA, EBA, EEA, EAS, EVK, ETFE, PEC, CSM, VPE, EPB, EPDM, ERM, polybutylene, and polyisobutylene. Phenolic compounds preferably mean 2,4,4′-trichloro-2′-hydroxyphenyl ether. Such end uses as boxes, containers and waste containers for storage and transportation are mentioned

Patent application FI 971338 discloses coatings of structures and profiled articles containing a mixture of thermoplastic elastomer with a non-elastomeric polyolefin, in general with homopolymers or random copolymers of propylene. An oligomer of poly-α-olefine type is used as the polyolefin plastisizer in a matrix plastic (EPR, EBR, EPBR, PBR, SBR, EPM, EPDM). The monomers used comprise at least 3 carbon atoms, preferably 6 to 12 carbon atoms. For example, reference is made to U.S. Pat. No. 4,032,591 and EP Patent 31S186 wherein 1-decene is mentioned.

Patent application WO 99/27792 discloses a concentrate containing biocides comprising zinc pyridine and another biocide, preferably a halogenated phenol, preferably 25 to 45% by weight of 2,4,4′-trichloro-2′-hydroxyphenyl ether. Cleaning devices and plastic materials are mentioned as end uses. In addition, the production thereof is disclosed. The biocidal compound is dissolved in a plastisizer to be added to the polymer being produced. Suitable plastisizers are polybutylene, LDPE, LDPP, and paraffin wax.

Polyalphaolefins are liquid oils, the starting materials of which are monomers having most suitably 8 to 12 carbon atoms. The most common starting material is the decene (C₁₀).

The term polyolefin refers to all such thermoplastics wherein the carbon skeleton of the polymer is formed by polymerizing monomers having carbon-carbon double bonds. In this polymerization, these double bonds are opened to form carbon-carbon bonds between the monomers. These polyolefins include for instance polyethylene, polypropylene, EPR, SBR, EBA, EMA, and EVA.

The object of the present invention is to provide an antimicrobial polyalphaolefin composition comprising polyalphaolefin and antimicrobial compound/compounds, and the use of this antimicrobial polyalphaolefin composition for various applications.

The characteristic features of the antimicrobial polyalphaolefin compositions of the present invention, and the uses thereof are disclosed in the appended claims.

It is found that colourless, odourless, tasteless and clear antimicrobial polyalphaolefin compositions may be produced from polyalphaolefins, preferably from polydecenes, and more preferably from food grade hydrogenated polydecenes by adding to this polydecene 0.01 to 30% by weight of 2,4,4′-trichloro-2′-hydroxydiphenyl ether (triclosan), or 0.01 to 5% by weight of n-propyl ester of hydroxybenzoic acid, or n-methyl ester of hydroxybenzoic acid (paraben) or mixtures thereof, optionally by using heat.

Particularly preferable polydecenes are food grade polydecenes NEXBASE™ 2004FG, NEXBASE™ 2006FG, and NEXBASE™ 2008FG (Fortum Oil and Gas Oy). 0.01 to 30% by weight of triclosan and/or 0.01 to 5% by weight of paraben may be dissolved in polydecene at the temperature of 10 to 90° C. depending on the concentration desired. Thus, an oily antimicrobial composition is obtained that is suitable for several applications in foor, pharmaceutical, technochemical, and cosmetics industry, and in hospitals. Further, it may also be used as an antimicrobial plastisizer in the plastics industry.

The composition of the invention may be used in food industry as a protecting and lubricating oil for machines to prevent in the oil the growth of microbes that are unwanted and hazardous to health, and further, to prevent the passing thereof from the oil to the products. Said antimicrobial compositions may also be used as protecting and lubricating oils of apparatuses in pharmaseutical industry to reduce any contamination risk. The antibacterial polyalphaolefin composition of the present invention may be used as such as a skin care oil and as a product to be applied on the skin in connection with the use of prostheses before the disposition thereof to prevent the microbial growth under the prostheses and unpleasant odour, and for other similar applications in connection with the use of prostheses. The antimicrobial composition of the invention may also be used to impregnate various wooden surfaces and wooden products particularly under circumstances where it is very important to prevent the unwanted growth of microbes and the deterioration of the wooden surface. Tooth picks impregnated with the composition of the invention may be mentioned as an example for such use. Moreover, the composition of the invention may be used to treat and polish leather.

The composition is also particularly useful as an antimicrobial plastisizer to simultaneously improve the antimicrobial properties of rubber mixtures, thermoplastic elastomers, thermoplastic vulcanizates and silicones. Plastisizing agents and oils are used in rubber mixtures (a), thermoplastic elastomers (b), vulcanizates thereof (c) and silicones (d) to plastisize the hardness of the product and to provide more flexible products having a soft surface and a lower residual compression, the products being suitable for lower working temperatures.

(a) Normally Plastisized Rubbers (Elastomers):

EPR=ethylene-propylene rubber

EPDM=ethylene-propylene-diene rubber

NR=natural rubber

IIR=butyl rubber

ACM/EAM=polyacrylate rubber

SBR=styrene-butadiene rubber

1,2-sPB=1,2-syndiotactic polybutadiene rubber.

(b) Plastisized Thermoplastic Elastomers; Polypropylene Commonly as a Crystalline Thermoplastic in a Mixture:

SBC=styrene-butadiene blockcopolymers,

| unhydrogenated version | hydrogenated version |
|---|---|
| SBS | SEBS |
| SB | SEB |
| SI | SEP |

EPR=ethylene-propylene rubber

EPDM=ethylene-propylene-diene rubber

NR=natural rubber

IIR=butyl rubber

ACM/EAM=polyacrylate rubber

SBR=styrene-butadiene rubber

1,2-sPB=1,2-syndiotactic polybutadiene rubber.

(c) Thermoplastic Vulcanizates:

Vulcanization is accomplished while mixing either by means of a sulfur compound, organic peroxide, or with a phenolic resin according to the type of the elastomer.

(d) Silicones.

In many cases, the use of a plastisizer lowers the raw material costs of the products and improves the processibility thereof. An advantage attained with the addition of a plastisizer is the improvement of the collapse resistance of an article made of thermoplastic elastomer exposed to oil in the environment. Plastisizers present in the product reduce the ability thereof to absorb additional hydrocarbons.

No plastisizers may be used in crystalline plastics since the crystalline structure will not tolerate the presence of an oil. Unplastisized plastics typically include polycarbonates, polyolefins (PE and PP), polyamides and polyurethanes. Compounding these plastics with elastomers provides in certain cases mixtures that may be plastisized.

With respect to performance, polyalphaolefins have several advantages in plastisizing applications. For instance:

superior heat resistance is an important feature in medical apparatus and device applications requiring repeated sterilization or heating of the article in a microwave oven, for instance as a component of a food tray. There are also other applications profiting from the high heat resistance, such as cable applications and engine room applications in automobile industry.

strictly limited composition, that is, a narrow molecular weight distribution allows for the selection of the desired molecular weight, thus minimizing the evaporation effects of the plastisizing agent or oil. In addition, the flash point of polyalphaolefin is generally higher at the desired viscosity than that of conventional mineral oils, this being favourable for processing. With respect to its quality, polyalphaolefin is a pure product, thus often facilitating the approval by the authorities.

a low working temperature is an important characteristic of polyalphaolefins. They crystallize at very low temperatures, thus making possible to lower the brittle temperature of rubber or a thermoplastic elastomer. This property is particularly advantageous for styrene elastomers. In applications of the automobile industry, the required lowest working temperature is commonly below 40° C.

Since 2,4,4′-trichloro-2′-hydroxyphenyl ether (triclosan) is very soluble in polyalphaolefins, a triclosan concentration necessary for the improvement of the antimicrobial properties of an elastomer products may be attained in plastisizer application. Moreover, the antimicrobial spectrum of triclosan is very wide, as the Table 1 below shows. By combining this wide spectrum antimicrobial activity with the favourable properties of polyalphaolefins, a composition particularly suitable for medical and medicinal apparatus and device applications and for seals of food packages is obtained.

TABLE 1
Microbiostatic effect of triclosan (Irgaguard B 1000)

| | | | | IRGAGUARD | |
|---|---|---|---|---|---|
| | | Strain | | B 1000 | |
| Gram-positive bacteria | Origin | No. | Medium | [ppm] | Comment |
| Actinomyces bovis | A | | NA | 1.0 | |
| Actinomyces israelii | NCTC | 8047 | NA | 1.0 | |
| Actinomyces naeslundii | A | | NA | 1.0 | |
| Bacillus cereus | A | | NA | 3.0 | |
| Bacillus cereus var. mycoides | A | | NA | 3.0 | |
| Bacillus megatherium | A | | NA | 3.0 | |
| Bacillus subtilis | NCTC | 8236 | NA | 0.1 | |
| Clostridium botulinum | NCTC | 3805 | EA | 3.0 | |
| Clostridium difficile | ATCC | 9684 | BHI-A | 5.0 | |
| Clostridium perfringens | NCTC | 3110 | EA | 10.0 | |
| Clostridium sporogenes | A | | EA | 10.0 | |
| Clostridium tetani | NCTC | 9571 | EA | 3.0 | |
| Corynebacterium acnes* | ATCC | 6919 | BHI-A | 3.0 | |
| Corynebacterium diphtherias | NCTC | 3984 | BHI-A | 3.0 | |
| Corynebacterium minutissimum | ATCC | 23348 | BHI-A | 3.0 | |
| Corynebacterium xerosis | ATCC | 373 | M-H | 5.0 | |
| Enterococcus faecalis | ATCC | 29212 | M-H | 4.0 | |
| Enterococcus faecalis | ATCC | 6055 | M-H | 5.0 | |
| Enterococcus faecalis | NCTC | 12201 | M-H | 5.0 | Varicomycin resistant |
| Enterococcus faecalis | NCTC | 12203 | M-H | 5.0 | Varicomycin resistant |
| Enterococcus faecium | ATCC | 10541 | BHI-A | 3.0 | |
| Enterococcus faedium | NCTC | 8619 | BHI-A | 10.0 | |
| Enterococcus faedium | ATCC | 6057 | M-H | 4.0 | |
| Enterococcus arabinosus | ATCC | 8014 | MACA | 33.0 | |
| Lactobacillus delbrueckii | ATCC | 7830 | MACA | 33.0 | |
| Lactobacillus fermenti | ATCC | 707 | MACA | 33.0 | |
| Lactobacillus rhamnosus | NCTC | 7469 | MACA | 33.0 | |
| Listeria monocytogenes | ATCC | 15313 | BHI-A | 1.0 | |
| Micrococcus luteus | ATCC | 7468 | M-H | 4.0 | |
| Mycobacterium phlei | A | | BHI-A | 0.3 | |
| Mycobacterium smegmatis | NCTC | 8152 | BHI-A | 1.0 | |
| Mycobacterium tuberculosis | A | | YA | 100.0 | |
| Nocardia asteroides | NCTC | 6761 | BHI-A | 3.0 | |
| Sarcina lutee | NCTC | 196 | BHI-A | 3.0 | |
| Sarcina urea | ATCC | 6473 | BHI-A | 0.1 | |
| Sporosarcina urea | ATCC | 6473 | BHI-A | 0.1 | |
| Staphylococcus aureus | ATCC | 29213 | M-H | <0.125 | |
| Staphylococcus aureus | NCTC | 6571 | NA | 0.03 | |
| Staphylococcus aureus | ATCC | 9144 | M-H | 0.05 | |
| Staphylococcus aureus | NCTC | 6966 | NA | 0.1 | |
| Staphylococcus aureus | ATCC | 13709 | NA | 0.01 | |
| Staphylococcus aureus | ATCC | 6538 | NA | 0.01 | |
| Staphylococcus aureus | NCTC | 11940 | M-H | 0.01 | Methicillin resistant |
| Staphylococcus aureus | NCTC | 12232 | M-H | 0.01 | Methicillin resistant |
| Staphylococcus aureus | NCTC | 12493 | M-H | 0.01 | Methicillin resistant |
| Staphylococcus aureus | NCTC | 12497 | M-H | 0.01 | Methicillin resistant |
| Staphylococcus aureus | NCTC | 10443 | M-H | 0.01 | Methicillin resistant |
| Staphylococcus aureus | NCTC | 10703 | M-H | 0.01 | Methicillin resistant |
| Staphylococcus aureus | NCTC | 11150 | M-H | 0.02 | Methicillin resistant |
| Staphylococcus albus | NCTC | 7292 | NA | 0.1 | |
| Staphylococcus epidermidis | ATCC | 12228 | M-H | <0.125 | |
| Staphylococcus hominis | ATCC | 27844 | M-H | 1.0 | |
| Staphylococcus hyicus | NCTC | 7944 | BHI-A | 0.03 | |
| Staphylococcus lactis | NCTC | 8340 | NA | 3.0 | |
| Staphylococcus saprophyticus | NCTC | 7292 | NA | 0.1 | |
| Streptococcus agalactiae | NCTC | 8181 | BHI-A | 3.0 | |
| Streptococcus heamolyticus A | A | | BHI-A | 3.0 | |
| Streptococcus pneumoniae | ATCC | 33400 | M-H | 4.0 | |
| Streptococcus pyogenes | ATCC | 21059 | M-H | 4.0 | |
| Streptococcus saprophyticus | ATCC | 15305 | M-H | 0.125 | |
| Streptococcus coelicolor | A | | BHI-A | 1.0 | |
| | | | | IRGAGUARD | |
| | | Strain | | B 1000 | |
| Gram-negative bacteria | Origin | No. | Medium | [ppm] | Comment |
| Aerobacter arogenes | CITM | 413 | NA | 1.0 | |
| Acinetobacter lwoffii | ATCC | 15309 | M-H | 0.125 | |
| Alcaligenes faecalis | A | | NA | >100 | |
| Bacteroides fragilis | ATCC | 23745 | M-H | 2.0 | |
| Brucella abortus | NCTC | 8226 | BR.A.A. | 0.1 | |
| Brucella intermedia | A | | BR.A.A. | 0.1 | |
| Citrobacter freundii | A | | NA | 3.0 | |
| Enterobacter aerogenes | ATCC | 13048 | M-H | 0.5 | |
| Enterobacter cloacae | ATCC | 13047 | M-H | 0.5 | |
| Enterobacter sakazakii | NCTC | 8155 | NA | 0.3 | |
| Escherichia coli | NCTC | 9663 | NA | 0.3 | |
| Escherichia coli | NCTC | 11186 | M-H | 0.5 | Tobramicin resistant |
| Escheria coli | ATCC | 8196 | M-H | 0.02 | |
| Escherichia coli | ATCC | 9661 | NA | 0.3 | |
| Escherichia coli | ATCC | 11229 | M-H | 0.5 | |
| Escherichia coli | ATCC | 25922 | M-H | 0.25 | |
| Escherichia coli | ATCC | 10536 | BHI | 0.5 | |
| Escherichia coli | ATCC | 35150 | M-H | 0.2 | Serotype 0157 |
| Escherichia coli | ATCC | 4388 | M-H | 0.1 | Serotype 0157 |
| Escherichia coli | ATCC | 43889 | M-H | 0.2 | Serotype 0157 |
| Escherichia coli | ATCC | 43890 | M-H | 0.2 | Serotype 0157 |
| Haemophilius influenca | ATCC | 33391 | B-A | 2.0 | |
| Klebsiella aerogenes | NCTC | 8172 | NA | 0.3 | |
| Klebsiella edwardsii | NCTC | 7242 | NA | 0.3 | |
| Klebsiella oxytoca | ATCC | 43165 | M-H | 1.0 | |
| Klebsiella pneumoniae | ATCC | 4352 | NA | 0.3 | |
| Klebsiella pneumoniae | ATCC | 10031 | M-H | 0.125 | |
| Loefferella mallei | NCTC | 9674 | NA | 0.3 | |
| Loefferella pseudomallei | NCIB | 10230 | NA | 1.0 | |
| Moraxella glucidolytica | A | | NA | 0.3 | |
| Moraxella lwolffii | A | | NA | 0.1 | |
| Neisseria catarrhalis | NCTC | 3622 | BA | 33.0 | |
| Pasteurella pseudotuberculosis | C-G | | NA | 10.0 | |
| Pasteurella septica | NCTC | 948 | NA | 0.1 | |
| Proteus mirabilis | ATCC | 14153 | M-H | 0.5 | |
| Proteus vulgaris | NCTC | 8313 | NA | 0.1 | |
| Proteus vulgaris | NCTC | 4636 | NA | 0.3 | |
| Pseudomonad aeruginosa | ATCC | 12055 | NA | >1000 | |
| Pseudomonas aeruginosa | NCTC | 8060 | NA | >1000 | |
| Pseudomonas fluorescencens | NCTC | 4755 | NA | >100 | |
| Salmonella enteritidis | A | | NA | 0.1 | |
| Salmonella paratyphi A | NCTC | 5322 | NA | 0.3 | |
| Salmonella paratyphi B | NCTC | 3176 | NA | 0.3 | |
| Salmonella paratyphi B | NCTC | 5704 | NA | 0.1 | |
| Salmonella typhimurium | NCTC | 5710 | NA | 0.3 | |
| Salmonella typhi | NCTC | 8384 | NA | 0.3 | |
| Salmonella typhi | NCTC | 786 | NA | 0.3 | |
| Serratia marcescens | ATCC | 14756 | M-H | >512 | |
| Shigella dysenteriae | NCTC | 2249 | NA | 0.1 | |
| Shigella flexneri | NCTC | 8192 | NA | 0.3 | |
| Shigella flexneri | NCTC | 8204 | NA | 0.1 | |
| Shigella sonnei | NCTC | 7240 | NA | 0.1 | |
| | | | | IRGAGUARD | |
| | | Strain | | B 1000 | |
| Gram-negative bacteria | Origin | No. | Medium | {ppm] | Comment |
| Vibrio cholerae | A | | NA | 10.0 | |
| Vibrio eltor | NCTC | 8457 | NA | 10.0 | |
| | | | | IRGAGUARD | |
| | | Strain | | B 1000 | |
| Molds and yeast | Origin | No. | Medium | [ppm] | Comment |
| Aspergillus fumigatus | ATCC | 9197 | SMA | 10 | |
| Aspergillus niger | ATCC | 6275 | M | 30 | |
| Candida albicans | ATCC | 10259 | M | 3 | |
| Candida albicans | A | | SMA | 10 | |
| Candida paracrusei | A | | SMA | 4 | |
| Candida parapsylosis | A | | SMA | 30 | |
| Candida stellatoidae | A | | SMA | 10 | |
| Candida tropicalis | A | | SMA | 10 | |
| Candida tropicalis | DSM | 1346 | M-H | 10 | |
| Candida utilis | A | | SMA | 33 | |
| Epidermophyton floccosum | ATCC | 10227 | SMA | 1-10 | |
| Keratinomyces ajelloi | A | | SMA | 10 | |
| Microsporum canis | ATCC | 10214 | SMA | 3 | |
| Pityrosporum ovalae | ATCC | 14521 | M | >1000 | |
| Trichophyton cutaneum | A | | SMA | 10 | |
| Trichophyton mentsgrophytes | ATCC | 9533 | SMA | 1 | |
| Trichophyton rubrum | A | | SMA | 10 | |
| Trochophyton tonsurans | A | | SMA | 10 | |

Key

| Media | | Origin | |
|---|---|---|---|
| NA | Nutrient Agar | CITM | official culture collection |
| BA | Blood Agar | DSM | German Collection of Microorganisms |
| | | | (Germany) |
| BR.A.A. | Brucella Agar Albimi | NCTC | National Collection of Type Culture (UK) |
| MACA | Micro Assay Culture Agar | ATCC | American Type culture collection (USA) |
| BHI-A | Brain Heart Infusion Agar | C-G | Ciba |
| EA | Eugon Agar | A | Bacteriological or veterinary Institutes |
| YA | Youmans Agar | | |
| M | Mycophil Agar | | |
| SMA | Sabouraud Maltose Agar | | |
| M-H | Muller Hinton Agar | | |

Elastomers and plastics used in medical applications and having a very high compatibility with polyalphaolefins include:

| | | Compatibility with |
|---|---|---|
| Type of plastic | Most common plastisizers | polyalphaolefins |
| PP/EPDM | Paraffin oil, naphtalene oil | Very high |
| PP/SBC | Paraffin oil, naphtalene oil | Very high |

Next, the use of antimicrobial polyalphaolefin composition of the invention as plastisizing agents in plastics is discussed in more detail.

1. Use of an Antimicrobial Polyalphaolefin Composition in Elastomers: PP/EPDM or PP/EPR Blend

| Raw material | %, by weight | |
|---|---|---|
| EPDM or EPR | 5 to 80 | |
| Polypropylene | 15 to 90 | |
| Plastisizer 1 | 5 to 30 | polyalphaolefin |
| Plastisizer 2 | 0 to 35 | mineral oil |
| Antimicrobial compound | 0.1 to 30 | triclosan |
| Antioxidant | 0 to 0.3 | |
| Peroxide | 0 to 0.1 | di-tert-butyl peroxide |
| Internal lubricant | 0 to 0.2 | magnesium stearate |

2. Use of a Antimicrobial Polyalphaolefin Composition in Styrene Based Thermoplastic Elastomer: SEBS Blend.

| Raw material | % by weight | |
|---|---|---|
| SEBS | 30 to 50 | |
| CaCO₃ | 0 to 20 | |
| Polypropylene | 0 to 30 | |
| Plastisizer 1 | 5 to 30 | polyalphaolefin |
| Plastisizer 2 | 0 to 35 | mineral oil |
| Antimicrobial compound | 0.1 to 30 | triclosan |
| Antioxidant | 0 to 0.3 | |

The combination PP/SEBS is generally used in those applications of styrene elastomers that are more demanding with respect to working temperature and environmental pollution.

Typical medical uses of elastomers are syringes and needles, intravenous, urinary catheters, dosage tubings and devices, clinical cardiac valves and vessel implants, disposable packages and trays.

The antimicrobial polyalphaolefin composition of the invention has several advantages. At lower concentrations of the antimicrobial agents, preferably at 0.01 to 5%, more preferably 0.1 to 2% by weight, the composition may be used as a skin oil, or on the skin in connection with prosthesis, and further, to impregnate leather and wooden surfaces. According to studies, reddening, abrasion, callousness and infections of the skin are reduced by more than 80% among carriers of prosthesis. Thus, the spreading and growth of microbes and the accompanying health risk may be prevented, and the deterioration of products hindered.

In food and pharmaceutical industry, contamination of products by unwanted microbes is both a serious economic risk factor and a health hazard to the consumers. The risk of microbial contamination may be reduced and prevented by using the antimicrobial polyalphaolefin composition of the invention containing 0.1 to 5%, preferably 0.1 to 2% by weight of the antimicrobial agent as the protecting and lubricating oil in apparatuses wherein the oil may find its way into the product contacting them.

In skin care applications, moisturizing and repairing properties of the antimicrobial polyolefin may be improved by adding vitamin compounds (retinyl palmitate or vitamin A, and tocopherol acetate or vitamin E) soluble in fat. As in known, vitamins A and E effectively moisturize of the skin, alleviate effects due to ageing, and promote the renewal thereof. Vitamin E is also an antioxidant.

Antimicrobial polyalphaolefin oil containing vitamins may be used as plastisizer for instance in silicone materials and elastomers. It is possible to produce a material exuding oil that is very comfortable in use. For instance, it may be used to treat wounds and burns since it will not stick to the skin and has nourishing properties.

In plastisizer applications, the antimicrobial polyalphaolefin composition has important advantaged, including the possibility to incorporate antimicrobial triclosan into plastic in an amount of 0.01 to 30% by weight, and/or a desired amount of paraben dissolved in polydecene. Further, the ratio of polydecene to antimicrobial agent may be freely adjusted by means of optional heat during dissolution of the agent, and the amount of polydecene. The composition optionally having a temperature of 10 to 90° C. may be mixed to elastomers and plastics during the production thereof preferably to obtain a content of triclosan of 0.1 to 1.0% by weight of the plastic product. In this manner, the preparation of separate “master batches” is avoided, thus lowering the costs and reducing process steps. Elastomer and plastic products particularly useful in medical and medicinal apparatus applications are thus obtained. In such final uses, it is extremely important to be able to prevent and/or reduce growth of unwanted microbes on apparatuses and devices, thus considerably lowering the costs due to infections caused by such unwanted microbes among patients. Medical applications have several special requirements on materials such as resistance to sterilization. These requirements are restricted in no way by the composition of the invention.

The invention will now be illustrated in more detail with the following examples without wishing to limit it to these exemplary solutions.

### EXAMPLE 1

Bacteriostatic Effect of the Antimicrobial Polydecene Composition

The antimicrobial composition of the invention comprised hydrogenated polydecene and 0.3% by weight of triclosan. The activity of the composition was tested and the composition was found to have a bacteriostatic effect on Staphylococcus aureus NCTC4163, Escherichia coli NTCT10538, Klebsiella pneumoniae ATCC27736, and Proteus vulgaris NTCT4635 strains.

### EXAMPLE 2

Tooth picks were impregnated with an antimicrobial polydecene composition of the invention containing 0.3% by weight of triclosan. The picks were then cultivated on a plate with the bacterium Staphylococcus aureus. It was found that the growth of the bacteria was effectively inhibited.

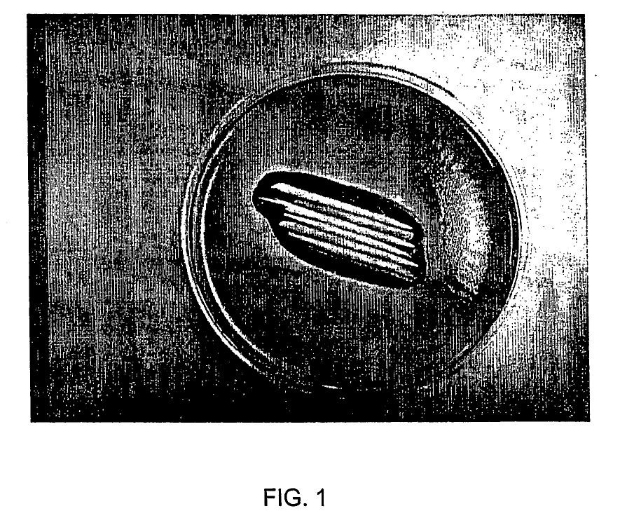

A photo of a cultivation plate of the tooth picks is shown in FIG. 1.

Use of Antimicrobial Polyalphaolefin Composition in Plastisizers

### EXAMPLE 3

Elastomer: EPDM or PP/EPR Blend

| Raw material | % by weight | Products |
|---|---|---|
| EPDM or EPR | 59.8/59.5 | Vistalon 805/Nordel IP 3745P |
| Polypropylene | 29 | Escorene PP 4152 |
| Plastisizer 1 | 10 | polydecene |
| Plastisizer 2 | 0 | mineral oil |
| Antimicrobial agent | 0.3 | triclosan |
| Antioxidant | 0.3 | Irganox B-225 |
| Peroxide | 0.1 | di-tert-butyl peroxide |
| Internal lubricant | 0.2 | magnesium stearate |

With the composition of the example, good processing characteristics and a Shore A hardness of 85 are attained. In addition, the antimicrobial properties of the composition are comparable to those in preceeding examples. Thermal ageing properties of the mixture are also especially good.

### EXAMPLE 4

Styrene Based Thermoplastic Elastomer: SEBS Blend

The example is directed to a basic SEBS blend. The combination PP/SEBS is generally used in those applications of styrene elastomers that are demanding with respect to working temperature and environmental pollution.

| Raw material | % by weight | Products: |
|---|---|---|
| SEBS | 30 | Shell Kraton G-1651 |
| CaCO₃ | 15 | Omycarb 2A, OMYA |
| Polypropylene | 13.4 | Escorene PP 4152 |
| Plastisizer 1 | 35 | polydecene |
| Plastisizer 2 | 0 | mineral oil |
| Antimicrobial compound | 0.3 | triclosan |
| Antioxidant | 0.3 | Irganox B-225 |

The ability to plastisize SEBS elastomers greatly depends on the styrene content thereof. An elastomer with a low styrene content accepts plastisizer more than 1.5 times its own weight. The antimicrobial properties of the exemplary mixture are comparable to those in examples 1 and 2.

### EXAMPLE 5

AATCC method 147-1998 (Antimicrobial Activity of Textile Materials: Parallel Streak Method) was used as the test method. Test microbes (Staphylococcus aureus) were cultivated on blood plates according to sensitivity assay technique. The preparates were placed in contact with the agar, and the plates were incubated at 35° C. over night. The bacteriostatic activity was assayed as the width of the inhibition zone around the sample or as reduced growth under the sample.

TABLE 1
Antimicrobial activity of elastomers

| | EPDM | SEBS |
|---|---|---|
| Inhibition zone, mm | 12 | 10 |
| Inhibition zone, mm, 100 h at 125° C. | 4 | 2 |
| Inhibition zone, mm, 240 h at 125° C. | 1 | no growth |
| | | under sample |

The antimicrobial properties of the blend make it very suitable for instance for medical applications. Antimicrobial properties of the elastomers are not lost even after extended heat treatment.

1. Antimicrobial polyalphaolefin composition, characterized in that said composition comprises polyalphaolefin and 0.01 to 30% by weight of 2,4,4′-trichloro-2′-hydroxyphenyl ether, and/or 0.01% by weight of paraben as antimicrobial compounds.

2. Antimicrobial polyalphaolefin composition of claim 1, characterized in that said polyalphaolefin is a hydrogenated polydecene.

3. Antimicrobial polyalphaolefin composition of claim 1 or 2, characterized in that said composition comprises vitamin A and/or E.

4. Use of an antimicrobial polyalphaolefin composition of claim 1 or 2 as a protecting and lubricating oil in food, technochemical, and pharmaceutical industries.

5. Use of an antimicrobial polyalphaolefin composition of claims 1 to 3 in cosmetics industry, and the use thereof as a skin care oil, or on the skin in connection with the use of prostheses.

6. Use of an antimicrobial polyalphaolefin composition of claim 1 or 2 for impregnation of wooden products and wood, and for the treatment and polishing of leather.

7. Use of an antimicrobial polyalphaolefin composition of claim 1 or 2 as a plastisizer in rubber mixtures, thermoplastic elastomers, thermoplastic vulcanizates, and silicones to improve the antimicrobial properties thereof.

8. Process for producing rubber mixtures, thermoplastic elastomers, thermoplastic vulcanizates, and silicones, characterized in that an antimicrobial polyalphaolefin composition of claim 1 or 2 is used as the plastisizer in said production.

9. Process of claim 8, characterized in that said antimicrobial polyalphaolefin composition is added to said rubber mixtures, thermoplastic elastomers, thermoplastic vulcanizates, and silicones, optionally heated to a temperature between 10 and 90° C., to the final concentration of 0.1 to 1.0% by weight of 2,4,4′-trichloro-2′-hydroxyphenyl ether, and/or paraben in plastic product.

10. Process of claim 8 or 9, characterized in that said thermoplastic elastomer is a PP/EPDM or PP/EPR blend or a styrene based thermoplastic elastomer, preferably a SEBS blend.
